(19) United States
(12) Patent Application Publication
(10) Pub. No.: US 2007/0024109 A1
(43) Pub. Date: Feb. 1, 2007

(54) Accumulator

(76) Inventors: Hisao Yoshihara, Ogasa-gun (JP); Kennji Sasaki, Ogasa-gun (JP)

Correspondence Address: JACOBSON HOLMAN PLLC, 400 SEVENTH STREET N.W., SUITE 600, WASHINGTON, DC, 20004, US

(21) Appl. No.: 10/556,364

(22) PCT Filed: May 14, 2004
(86) PCT No.: PCT/JP04/06529

§ 371 Date: Nov. 10, 2005

(30) Foreign Application Priority Data
May 16, 2003 (JP) 2003-138303

(51) Int. Cl. B60T 17/04

(52) U.S. Cl. 303/87

(57) ABSTRACT

To provide an accumulator which is capable of relieving a pressure in a seal attaching portion (a portion under a seal) in order to make the attached state of a seal stable and prevent slipping off of the seal from the seal attaching portion, the seal attaching portion with which a working member is freely contacted and released and a seal holder attaching portion attaching a seal holder holding the seal are provided around a pressure inflow port inside the inner surface of a housing receiving the working member such as a bellows cap, the seal is attached to the seal attaching portion, the seal holder is attached to the seal holder attaching portion by fixing means such as welding, bonding, screwing, engaging, or fitting, and a pressure relief path is provided for relieving the pressure in the seal attaching portion generated by attaching of the seal thereon.

### TECHNICAL FIELD

The present invention relates to an accumulator used as a pressure accumulating apparatus or a pulse pressure damping apparatus or the like. The accumulator in accordance with the present invention is used, for example, as an accumulator for a motor vehicle.

### BACKGROUND ART

There has been developed in recent years an accumulator provided with a function of sealing a pressure in an inner portion of the accumulator between a bellows cap and an oil port at a time when a working pressure is lowered, in order as to prevent a bellows corresponding to a constituting part of the accumulator from being expanded in a diametrical direction due to a difference between internal and external pressures so as to be broken, for example, at a time when a pressure in an inner portion of a pipe in a brake system of the motor vehicle and a pressure in the inner portion of the accumulator connected to the pipe are lowered to zero or close to zero.

However, in this kind of accumulator, as shown in FIG. 13, since a seal holder 52 holding a seal 51 is fixed to an inner side of a housing 54 by a caulking means (a caulking portion is shown by reference numeral 53), it is necessary to deform a housing 54 at a time of caulking, so that there is a disadvantage that a lot of labor and time are required for executing the caulking work (refer to Japanese Unexamined Patent Publication No. 2002-276604).

Accordingly, the inventors of the present invention have developed a structure of fixing the seal holder 52 holding the seal 51 to the inner side of the housing 54 in accordance with a projection welding in place of the caulking, as shown in FIG. 14. The accumulator shown in FIG. 14 is structured as follows.

An annular seal attaching portion 56 for attaching the seal 51 is provided in an inner bottom surface of the housing 54 having a pressure inflow port 55 connected to a pressure pipe (not shown) or the like, and an annular seal holder attaching portion 57 for attaching the seal holder 52 is provided in an inner peripheral side thereof The seal 51 is attached to the former seal attaching portion 56 in an unbonded manner, and an outer peripheral surface 51a thereof is in close contact with an inner surface 56a of the seal attaching portion 56. The seal holder 52 is fixed to the latter seal holder attaching portion 57 in accordance with projection welding as described above, and an inner peripheral surface 51b of the seal 51 is in close contact with an outer peripheral surface 52a thereof.

The projection welding of the seal holder 52 with respect to the housing 54 is executed by welding a lower surface 52b of the seal holder 52 to a bottom surface 57a of the seal holder attaching portion 57, and the projection welding is applied to all the circumference of the seal holder 52. Accordingly, an annular projection 58 for the projection welding is previously provided in all the circumference of the seal holder 52 as shown in FIG. 15. In this case, since an upper end portion 52c of the seal holder 52 is previously formed in a trumpet shape, the seal 51 is engaged therewith after the attachment, whereby it is possible to prevent the, seal 51 from slipping off upward. (a direction of an arrow x) in the drawing. Accordingly, the seal holder 52 holds the seal 51.

However, in the accumulator shown in FIG. 14, since the projection welding of the seal holder 52 with respect to the housing 54 is applied to all the circumference of the seal holder 52 as mentioned above, the following disadvantage is generated.

If the pressure is sealed in the seal attaching portion 56, that is, the lower portion of the seal 51 at a time of manufacturing and assembling the accumulator, the pressure can not escape and is kept being sealed in the lower portion of the seal 51. Accordingly, the attached state of the seal 51 becomes unstable, and there is a risk that the seal portion 51 slips off from the seal attaching portion 56 beyond the upper end portion 52a of the seal holder 52 due to the unstableness.

### DISCLOSURE OF THE INVENTION

### Problem to be Solved by the Invention

The present invention is made by taking the points mentioned above into consideration, and an object of the present invention is to provide an accumulator which can relieve a pressure even if the pressure is sealed in a seal attaching portion, that is, a lower portion of a seal, thereby preventing an attached state of the seal from becoming unstable and preventing the seal from slipping off from the seal attaching portion.

### Means for Solving the Problem

In order to achieve the object mentioned above, in accordance with a first aspect of the present invention, there is provided an accumulator comprising:

a seal attaching portion attaching a seal with which a working member such as a bellows, a bellows cap and the like is freely brought into contact and released; and

a seal holder attaching portion attaching a seal holder holding the seal;

the seal attaching portion and the seal holder attaching portion being provided around a pressure inflow port inside an inner surface of a housing receiving the working member;

the seal being attached to the seal attaching portion; and

the seal holder being attached to the seal holder attaching portion by a fixing means such as welding, bonding, screwing, engaging or fitting,

wherein the accumulator is provided with a pressure relief path relieving a pressure sealed in the seal attaching portion by attaching of the seal to the outside of the seal attaching portion.

Further, in accordance with a second aspect of the present invention, there is provided an accumulator as recited in the first aspect mentioned above, wherein the pressure relief path is provided as a gap-shaped structure between the seal holder attaching portion and the seal holder attached to the seal holder attaching portion.

Further, in accordance with a third aspect of the present invention, there is provided an accumulator as recited in the second aspect mentioned above, wherein the pressure relief path is provided between the seal holder and the seal holder attaching portion by welding of the seal holder to the seal holder attaching portion in a part on the circumference thereof.

Further, in accordance with a fourth aspect of the present invention, there is provided an accumulator as recited in the second aspect mentioned above, wherein a plurality of pressure relief paths are provided between the seal holder and the seal holder attaching portion and between the weld portions by welding of the seal holder to the seal holder attaching portion at a plurality of positions on the circumference thereof.

Further, in accordance with a fifth aspect of the present invention, there is provided an accumulator as recited in any one of the first to fourth aspects mentioned above, wherein a gap is provided between the seal holder and the seal holder attaching portion by loose fitting of the seal holder to the seal holder attaching portion and the gap serves as a part of the pressure relief path.

Further, in accordance with a sixth aspect of the present invention, there is provided an accumulator as recited in any one of the first to fourth aspects mentioned above, wherein a groove-shaped or notch-shaped recess portion is provided in an inner surface of the seal holder attaching portion or a surface of the seal holder opposing to the inner surface, and the recess portion serves as a part or the entire of the pressure relief path.

Further, in accordance with a seventh aspect of the present invention, there is provided an accumulator as recited in the first aspect mentioned above, wherein the pressure relief path is provided as a through hole shaped structure in the housing or the seal holder.

Further, in accordance with an eighth aspect of the present invention, there is provided an accumulator as recited in any one of the first to seventh aspects mentioned above, wherein the housing has a shell and an oil port connected to the shell, and the seal attaching portion and the seal holder attaching portion are provided in an inner surface of the oil port.

As in the accumulator in accordance with the first aspect of the present invention provided with the structure mentioned above, in the case that the accumulator is provided with the pressure relief path relieving the pressure sealed in the seal attaching portion by attaching of the seal to the outer portion of the seal attaching portion, it is possible to relieve the pressure sealed in the seal attaching portion, that is, the lower portion of the seal to the outside through the pressure relief path.

The pressure relief path is provided as the gap-shaped structure between the seal holder attaching portion and the seal holder (the second and fifth aspects), however, may be provided as the groove-shaped structure, the notch-shaped structure or the through hole shaped structure (the sixth and seventh aspects) in addition to the gap-shaped structure. The fixing means of the seal holder with respect to the housing maybe various means such as welding, bonding, screwing, engaging, fitting or the like. In the case of welding, if the seal holder is welded to the seal holder attaching portion in a part of the circumference, the pressure relief path is formed between the seal holder and the seal holder attaching portion (the third aspect) Further, if the seal holder is welded to the seal holder attaching portion at a plurality of positions on the circumference, a plurality of pressure relief paths are formed between the seal holder and the seal holder attaching portion and between the weld portions (the fourth aspect). If a plurality of pressure relief paths are formed, it is possible to relieve the pressure from the other paths even in the case that one path is clogged.

Further, as in the accumulator in accordance with the fifth aspect of the present invention provided with the structure mentioned above, in the case that the gap formed between the seal holder attaching portion and the seal holder in accordance with the loose fitting is formed as a part of the pressure relief path, a sectional area of the opening of the pressure relief path is increased in a part. Accordingly, it is possible to quickly and securely relieve the pressure sealed in the seal attaching portion, that is, the lower portion of the seal.

Further, as in the accumulator in accordance with the sixth aspect of the present invention provided with the structure mentioned above, in the case that the groove-shaped or notch-shaped recess portion formed in the inner surface of the seal holder attaching portion or the surface of the seal holder opposing to the inner surface is formed as a part or an entire of the pressure relief path, the opening cross sectional area of the pressure relief path is increased in apart or the entire. Accordingly, it is possible to quickly and securely relieve the pressure sealed in the seal attaching portion, that is, the lower portion of the seal.

### EFFECT OF THE INVENTION

The present invention achieves the following effects.

In the accumulator in accordance with each of the aspects of the present invention provided with the structure mentioned above, since the accumulator is provided with the pressure relief path relieving the pressure sealed in the seal attaching portion by attaching of the seal to the outer portion of the seal attaching portion, it is possible to relieve the pressure sealed in the seal attaching portion, that is, the lower portion of the seal to the outside through the pressure relief path. Accordingly, it is possible to prevent the attached state of the seal from becoming unstable because of the pressure in the seal attaching portion being kept sealed, whereby it is possible to prevent the seal from slipping off from the seal attaching portion.

Further, in the accumulator in accordance with the fourth aspect, since a plurality of pressure relief paths are formed, it is possible to relieve the pressure from the other paths even in the case that one path is clogged.

Further, in the accumulator in accordance with the fifth aspect, since the opening cross sectional area of the pressure relief path is partly increased on the basis of the loose fitting, it is possible to quickly and securely relieve the pressure.

Further, in the accumulator in accordance with the sixth aspect, since the opening cross sectional area of the pressure relief path is partly increased by forming of the recess portion, it is possible to quickly and securely relieve the pressure in the same manner.

### Best Mode for Carrying Out the Invention

In this case, the following modes are included in the present application.

(1) A mechanism of relieving a pressure in a lower portion of a seal for preventing slipping off of the seal, wherein a number of projection weld portions between an oil port and a seal holder in a metal bellows type accumulator is set to six.

(2) A number of the projection weld portions of the seal holder is set to six, a relief route of the pressure is provided, the pressure is not sealed in the lower portion of the seal, and slipping off of a seal is prevented

(3) A number of the projection weld portions between the seal holder and the oil port in the metal bellows type accumulator is set to six, a mechanism by which the pressure is not closed in the lower portion of the seal is provided, and slipping off of the seal is prevented.

(4) In any one of the items (1) to (3) mentioned above, the seal holder and the oil port are loosely fitted so as to avoid the sealing (sizes are set such as to prevent them from being closely fitted (closely attached) in a dimensional tolerance).

(5) In any one of the items (1) to (3) mentioned above, a vertical groove is provided in the oil port or the seal holder so as to avoid the sealing (a groove is provided in a vertical direction in an interference portion between the oil port and the seal holder).

(6) In the case that the structure is made as in the items (1) to (5), it is possible to prevent the pressure sealing in the lower portion of the seal, whereby it is possible to prevent slipping off of the seal.

Further, in the present invention, the projection welding is preferably utilized as the welding method of the seal holder with respect to the housing, however, the welding method is not limited to this, and the other welding methods may be employed. Further, as described above, the fixing means of the seal holder with respect to the housing may be bonding, screwing, engaging, fitting or the like in addition to welding.

### BRIEF DESCRIPTION OF THE DRAWINGS

FIG. 1 is a vertical cross sectional view of an accumulator in accordance with a first embodiment of the present invention;

FIG. 2 is an enlarged vertical cross sectional view of a main portion of the accumulator;

FIG. 3 is a horizontal cross sectional view of the accumulator;

FIG. 4 is an explanatory view of a welding step in the accumulator;

FIGS. 5A and 5B are views showing the other example of a cross sectional shape of a welding projection, in which FIG. 5A is a vertical cross sectional view of a seal holder, and FIG. 5B is a bottom view of the seal holder;

FIG. 6 is a vertical cross sectional view of a main portion of an accumulator in accordance with a second embodiment of the present invention;

FIG. 7 is a vertical cross sectional view of a main portion of an accumulator in accordance with a third embodiment of the present invention;

FIG. 8 is a horizontal cross sectional view of the accumulator;

FIG. 9 is a vertical cross sectional view of a main portion of an accumulator in accordance with a fourth embodiment of the present invention;

FIG. 10 is a horizontal cross sectional view of the accumulator;

FIG. 11 is a vertical cross sectional view of a main portion of an accumulator in accordance with a fifth embodiment of the present invention;

FIG. 12 is a vertical cross sectional view of a main portion of an accumulator in accordance with a sixth embodiment of the present invention;

FIG. 13 is a vertical cross sectional view of an accumulator in accordance with a prior art;

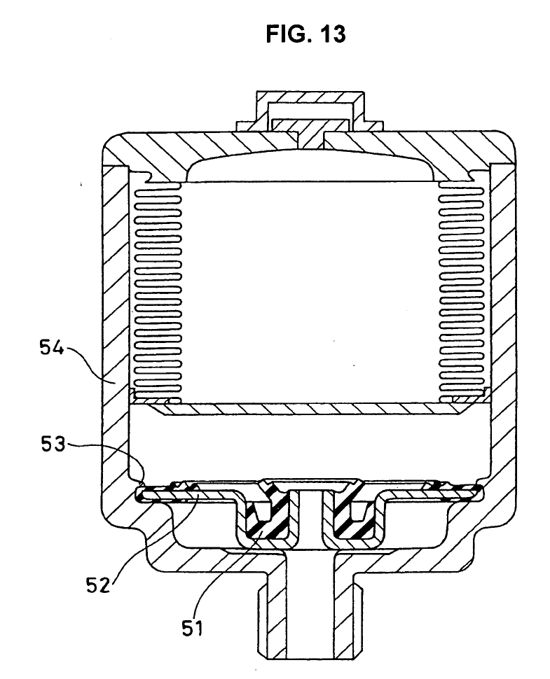

FIG. 14 is a vertical cross sectional view of a main portion of an accumulator in accordance with the other prior art; and

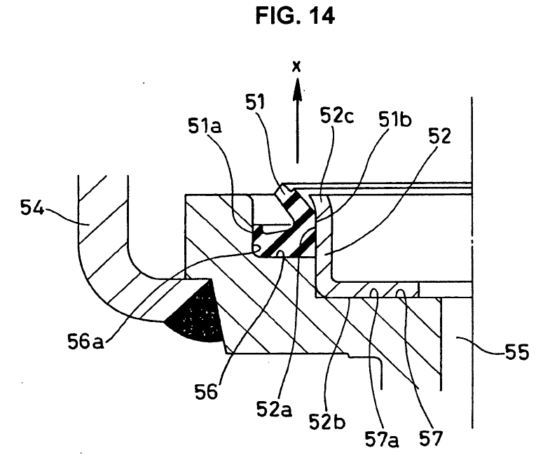

FIG. 15 is an explanatory view of a welding step in the accumulator.

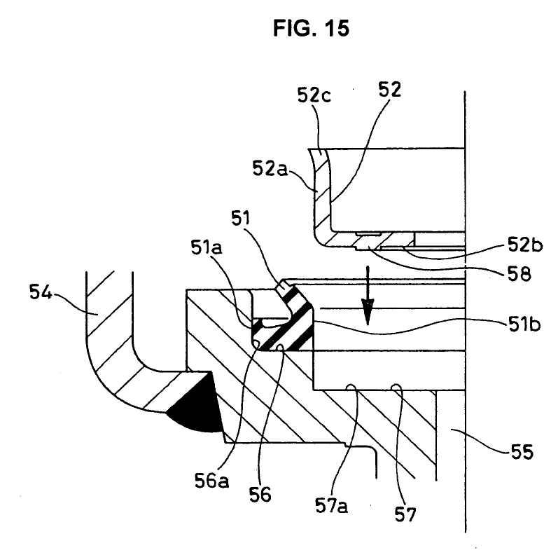

### DESCRIPTION OF REFERENCE NUMERALS

1 accumulator

2 housing

3 shell

4 gas end cover

5 oil port

6 working member

7 bellows

8 bellows cap

9 gas chamber

10 pressure chamber

11 vibration control ring

12 gas input port

13 gas plug

14 hexagonal nut

15 spacer

16 attaching portion

17 thread portion

18 pressure inflow port

19 seal attaching portion

19a, 21a bottom surface

19b, 21b inner side surface (inner surface)

20 seal

20a base portion

20b seal lip

20c, 22e outer peripheral surface

20d inner peripheral surface

20e, 22f lower surface

21 seal holder attaching portion

22 seal holder

22a flat portion

22b through hole

22c tubular portion

22d leading end portion

22g welding projection

23 stopper portion

24 chamber space

25 weld portion

26 pressure relief path

27 gap

28 recess portion

29 through hole

### Embodiment

Next, a description will be given of embodiments in accordance with the present invention with reference to the accompanying drawings.

### First Embodiment

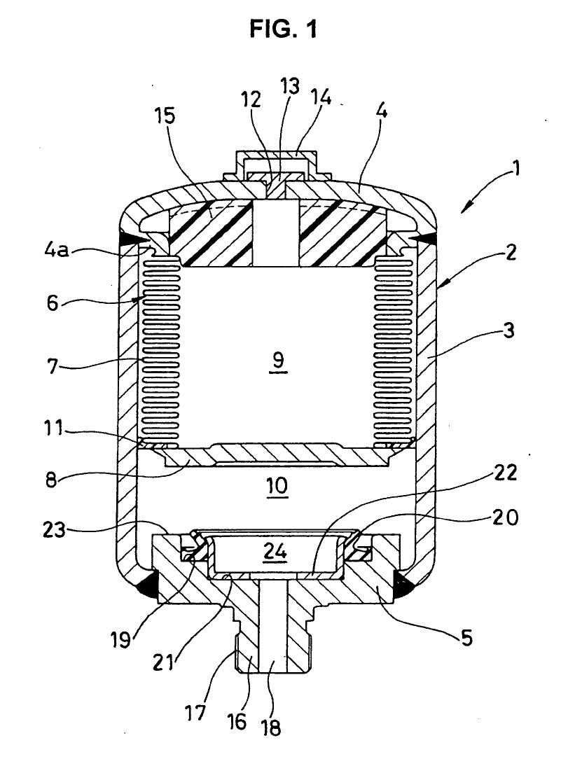

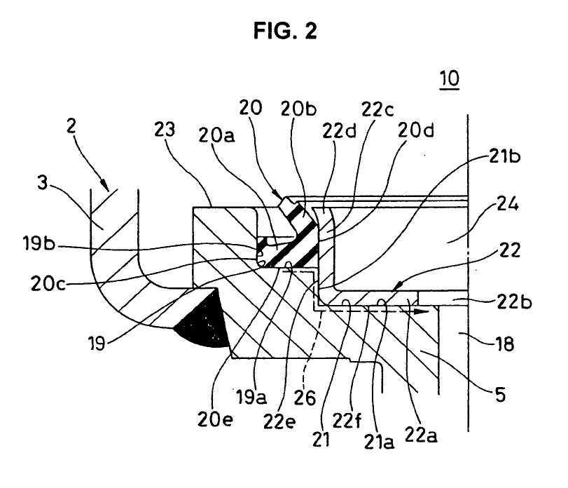

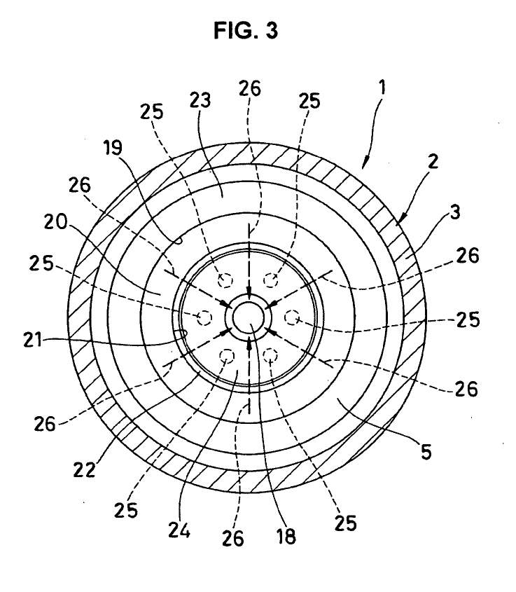

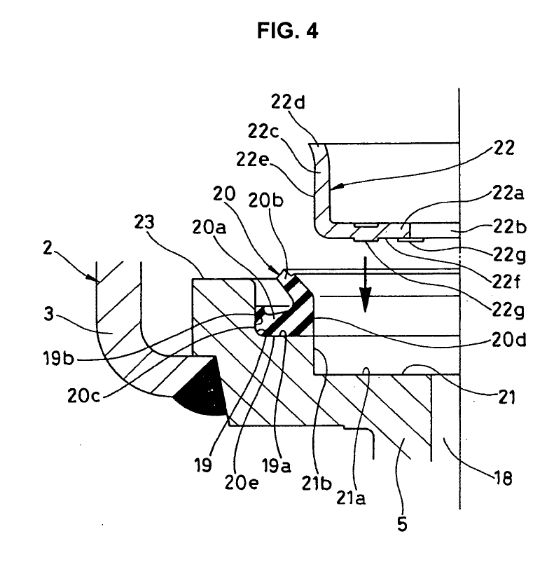

FIG. 1 shows a vertical cross section of an accumulator 1 in accordance with a first embodiment of the present invention, and an enlarged view of a main portion thereof is shown in FIG. 2. Further, FIG. 3 is a horizontal cross sectional view of the accumulator 1, and FIG. 4 is an explanatory view of a welding step.

The accumulator 1 in accordance with the embodiment is a metal bellows type accumulator, and is structured as follows.

A gas end cover 4 and an oil port (an oil port in a broad sense) 5 are fixed (welded) to both end portions of a shell 3 formed in an approximately cylindrical shape, a housing 2 is provided thereby, and a working member 6 provided with a bellows 7 and a bellows cap 8 is received in an inner portion of the housing 2. The gas end cover 4 maybe integrally formed with the shell 3, and the oil port 5 may be integrally formed with the shell 3.

The bellows 7 is structured such that one end portion (a fixed end portion) is fixed (welded) to the gas end cover 4 and the other end portion (a floating end portion) is fixed (welded) to the bellows cap 8, whereby an inner portion of the housing 2 is sectioned into a gas chamber 9 in an inner side of the working member 6 and a pressure chamber (a liquid chamber) 10 in an outer side thereof by the working member 6 constituted by the bellows 7 and the bellows cap 8. A vibration control ring 11 which is slidably in contact with an inner peripheral surface of the shell 3 is attached to an outer periphery in the other end portion of the bellows 7 in such a manner as to prevent the bellows 7 from being scraped by the shell 3. As the bellows 7 a metal bellows constituted by an electro-deposited bellows, a molded bellows, a weld bellows or the like is employed, however, a bellows made of the other material may be employed in accordance with a specification, an intended use or the like of the accumulator The bellows cap 8 may be integrally molded with the bellows 7. Further, one end portion of the bellows 7 is fixed to an inward flange portion 4a provided in an outer peripheral edge portion of the gas end cover 4, however, in the case that an annular attaching member (not shown) is fixed in place of the flange portion 4a, one end portion of the bellows 7 is fixed to the attaching member.

A gas input port 12 for injecting a gas to the gas chamber 9 is provided in the gas end cover 4 structuring a part of the housing 2, and a gas plug 13 for closing the input port 12 is attached to the input port 12 and is covered by a hexagonal nut 14. Accordingly, the gas, having predetermined pressure is sealed in the gas chamber 9 by injecting the gas having the predetermined pressure to the gas chamber 9 from the input port 12 before fixing the gas plug 13 and the hexagonal nut 14, and fixing (welding) the gas plug 13 and the hexagonal nut 14 after injecting. A nitrogen gas or the like is preferable as a kind of the sealed gas. In this case, a spacer 15 for regulating a volumetric capacity of the gas chamber 9 is assembled in an inner portion of the gas chamber 9, that is, an inner side of the gas end cover 4.

Further, the oil port 5 structuring a part of the housing 2 is provided with a tubular attaching portion 16 having a thread portion 17 for connecting the accumulator 1 to a pressure pipe or the like in the side of a hydraulic system (not shown), and the attaching portion 16 is provided with a pressure inflow port (an oil port in a narrow sense) 18 for introducing the pressure fluid in the pipe side to the pressure chamber 10. Accordingly, the accumulator 1 is connected to the pipe side at the attaching portion 16, and the pressure in the pipe side is introduced to the pressure chamber 10 from the pressure inlet port 18.

As shown in an enlarged manner in FIG. 2, an annular recess-shaped seal attaching portion 19 for attaching a seal 20 is provided in an inner surface (an upper surface) of the oil port 5, and an annular recess-shaped seal holder attaching portion 21 for attaching a seal holder 22 is provided in an inner peripheral side of the seal attaching portion 19, that is, between the seal attaching portion 19 and the pressure inflow port 18. An outer peripheral side portion of the seal attaching portion 19 is formed as an annular flat-shaped stopper portion 23 with which the working member 6 is brought into contact so as to stop at a time when the working member 6 is actuated so as to expand under the operation of the accumulator 1. A bottom surface 19a of the seal attaching portion 19 is formed in a flat shape which is one stage lower than the stopper portion 23, and a bottom surface 21a of the seal holder attaching portion 21 is formed in a flat shape which is further one stage lower than the bottom surface 19a of the seal attaching portion 19. Accordingly, the stopper portion 23, the seal attaching portion 19 and the seal holder attaching portion 21 are formed in this order from an outer peripheral side thereof so as to have the half section in a step shape in the inner surface of the oil port 5.

The seal 20 is formed in an annular shape with a predetermined rubber-like elastic body, and is formed as a lip seal in which an outward seal lip 20b is integrally formed in one end of a base portion 20a. The seal 20 is attached to the seal attaching portion 19 of the oil port 5 in an unbonded manner by means of a pressure insertion or the like, is closely contacted with an inner side surface (an inner surface) 19b of the seal attaching portion 19 by an outer peripheral surface 20c thereof after being attached, and is closely contacted with an outer peripheral surface 22e of the seal holder 22 by an inner peripheral surface 20d. Further, a leading end portion of a tubular portion 22c of the seal holder 22 (a leading end portion of the seal holder 22) 22d is bent diagonally (in a trumpet shape) toward an outer side in a diametrical direction as described later, whereby the seal 20 is prevented from slipping off. In this case, the seal 20 is provided in the manner mentioned above such that the bellows cap 8 is brought into contact with the seal 20 so as to carry out a seal function at a time when the pressure in the pressure chamber 10 is extremely lowered and the bellows 7 is expanded largely, thereby inhibiting the pressure in the pressure chamber from being further lowered, and inhibiting the bellows 7 from being expanded in the diametrical direction so as to be scraped by into the shell 3.

The seal holder 22 is formed in an annular shape with a metal material such as a sheet metal or the like and formed so as to have the half section in an approximately L shape by integrally forming the tubular portion 22c in an outer peripheral edge portion of a disc-shaped flat portion 22a provided with a through hole 22b in a center of the flat surface, and a leading end portion 22d of the tubular portion 22c is bent diagonally (in a trumpet shape) toward an outer side in the diametrical direction for holding the seal 20.

Further, the seal holder 22 is fixed to the inner surface of the oil port 5 in the housing 2, that is, the bottom surface 21a of the seal holder attaching portion 21 in accordance with a projection welding (an electric resistance welding), and a chamber space 24 for preventing an abnormal noise generation is formed in an inner side of the seal holder, that is, an inner peripheral side of the tubular portion 22c in this fixed state.

As shown in FIG. 4, the projection welding is executed by previously forming a welding projection 22g in a lower surface 22f of the flat portion 22a of the seal holder 22 and applying an electric current in a state in which the welding projection 22g is abut against the bottom surface 21a of the seal holder attaching portion 21. However, in the embodiment, the welding projections 22g are particularly arranged in a dotted manner at a plurality of positions on a circumference of the seal holder 22, and the projection welding is executed in a dotted manner at a plurality of positions on the circumference in accordance with this arrangement. Accordingly, as shown in FIG. 3, the welding portions 25 are provided at a plurality of positions on the circumference in the seal holder 22 after being welded. A portion between the weld portions 25 is referred to as a non-weld portion. A gap-shaped pressure relief path 26 having the non-weld portion as a part thereof is formed between the seal holder 22 and the oil port 5.

In particular, if the pressure is sealed in the seal attaching portion 19, that is, the lower portion of the seal 20 at a time of manufacturing and assembling the accumulator 1 as mentioned above, the pressure can not escape and is kept sealed in the lower portion of the seal 20. Accordingly, the attaching state of the seal 20 becomes unstable, and there is a risk that the seal 20 slips off from the seal attaching portion 19. However, in accordance with the accumulator 1, since the gap-shaped pressure relief path 26 capable of discharging the pressure in the seal attaching portion 19 to the outside is formed on the basis of the structure mentioned above, it is possible to relieve the pressure in the seal attaching portion 19 to the outside via the pressure relief path 26.

As shown in FIG. 2, the pressure in the seal attaching portion 19 is particularly accumulated in a space (not shown) surrounded by the bottom surface 19a of the seal attaching portion 19, the inner side surface 19b, the lower surface 20e of the seal 20 and the outer peripheral surface 22e of the seal holder 22. However, the pressure is discharged from this space to the inner peripheral side of the seal holder 22 via a gap (not shown) between the inner side surface (the inner surface) 21b of the seal holder attaching portion 21 and the outer peripheral surface 22e of the seal holder 22 and a gap (not shown) between the bottom surface 21a of the seal holder attaching portion 21 and the lower surface 22f of the seal holder 22. Accordingly, the pressure relief path 26 is particularly structured by the gap between the inner side surface 21b of the seal holder attaching portion 21 and the outer peripheral surface 22e of the seal holder 22, and the gap between the bottom surface 21a of the seal holder attaching portion 21 and the lower surface 22f of the seal holder 22.

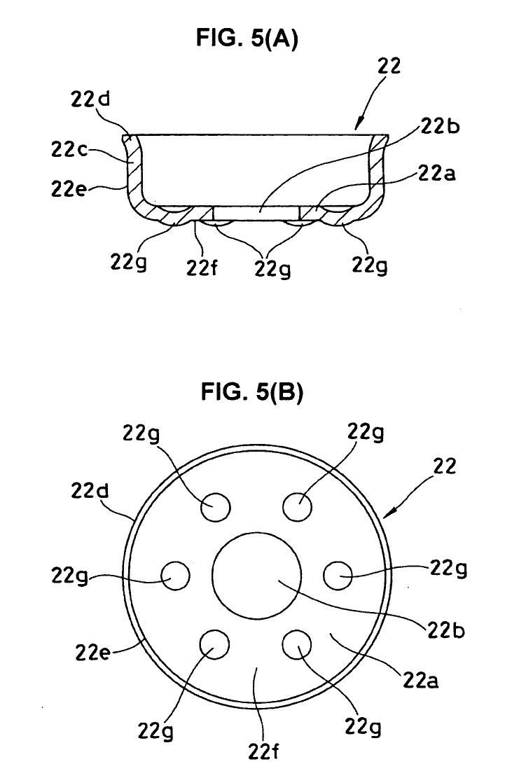

In this case, since the welding projections 22g and the weld portions 25 are arranged symmetrically at six positions on the circumference in the drawing, the pressure relief paths 26 are formed symmetrically at six positions on the circumference in correspondence thereto. Six pressure relief paths 26 are arranged in a radial pattern, and discharge the pressure toward a centripetal direction. A shape (a shape before being welded) of the welding projection 22g may be formed in a circular arc shape in section as shown in FIG. 5.

Further, in the first embodiment mentioned above, since apart of the pressure relief path 26 is structured by the gap between the inner side surface 21b of the seal holder attaching portion 21 and the outer peripheral surface 22e of the seal holder 22, the pressure relief path 26 is narrow if both the surfaces 21b and 22e are closely fitted in dimension setting. Accordingly, there is a risk that the pressure can not be well relieved. Therefore, in this case, it is preferable that the following countermeasure is added.

### Second Embodiment (First Countermeasure)

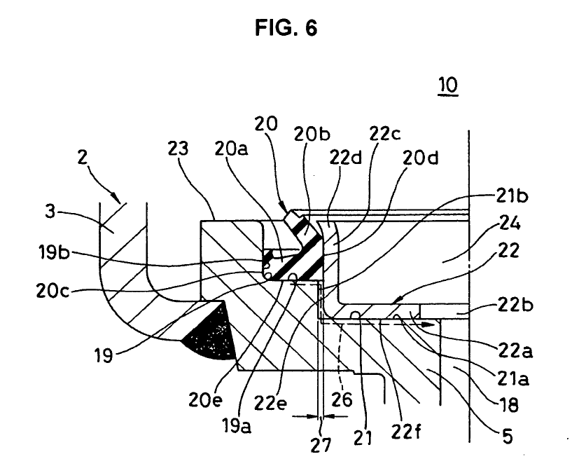

In addition to the structure of the first embodiment mentioned above, as shown in FIG. 6, the inner side surface 21b of the seal holder attaching portion 21 and the outer peripheral surface 22e of the seal holder 22 are loosely fitted in the diametrical direction in the dimension setting so as to form a gap (a gap in a diametrical direction) 27 between both the surfaces 21b and 22e, and the gap 27 is used as a part of the pressure relief path 26. In accordance with the structure mentioned above, since the sectional area of the opening of the pressure relief path 26 is substantially increased in the portion, it is possible to quickly relieve the pressure. The loose fitting is structured such as to form the annular gap 27 between both the surfaces 21b and 22e by making the diametrical size of the inner side surface 21b of the seal holder attaching portion 21 larger than the diametrical size of the outer peripheral surface 22e of the seal holder 22.

### Third Embodiment (Second Countermeasure)

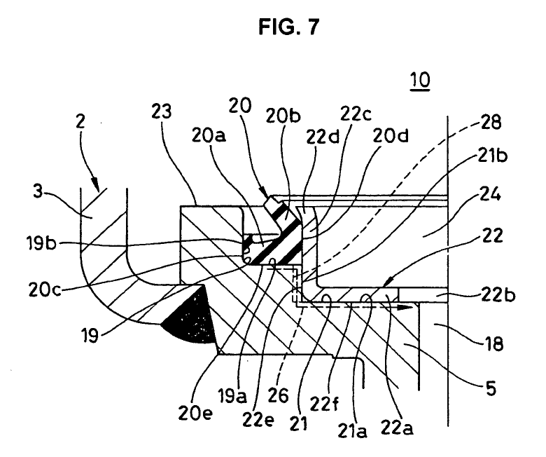

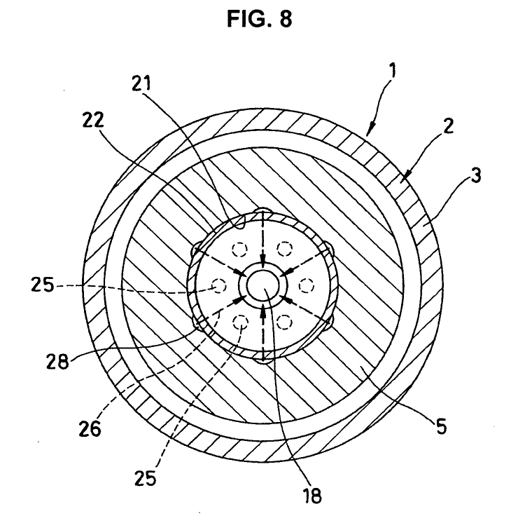

In addition to the structure of the first embodiment mentioned above, as shown in FIGS. 7 and 8, a vertically extending groove-shaped or notch-shaped recess portion 28 is formed in the inner side surface 21b of the seal holder attaching portion 21, and the recess portion 28 is used as a part of the pressure relief path 26. In accordance with the structure mentioned above, since the sectional area of the opening of the pressure relief path 26 is substantially increased in the portion, it is possible to quickly relieve the pressure in the same manner. In this case, in the first embodiment mentioned above, since the pressure relief paths 26 are set at a plurality of positions on the circumference, it is preferable that the recess portions 28 are formed at a plurality of positions on the circumference. In the drawing, since the pressure relief paths are set at six positions on the circumference, the recess portions 28 are formed at six positions on the circumference. Further, it is preferable that the recess portion 28 is arranged at an intermediate position between the adjacent weld portions 25 and 25 on the circumference.

### Fourth Embodiment (Third Countermeasure)

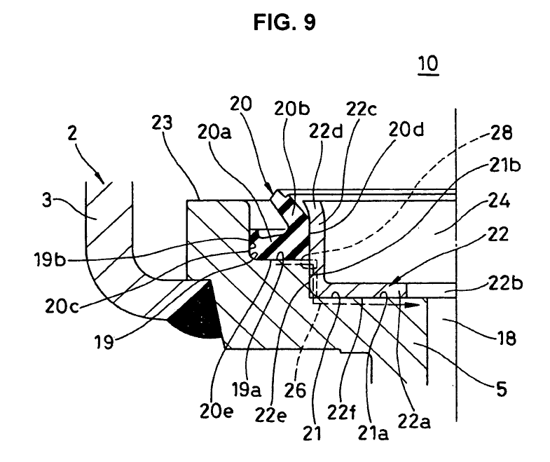

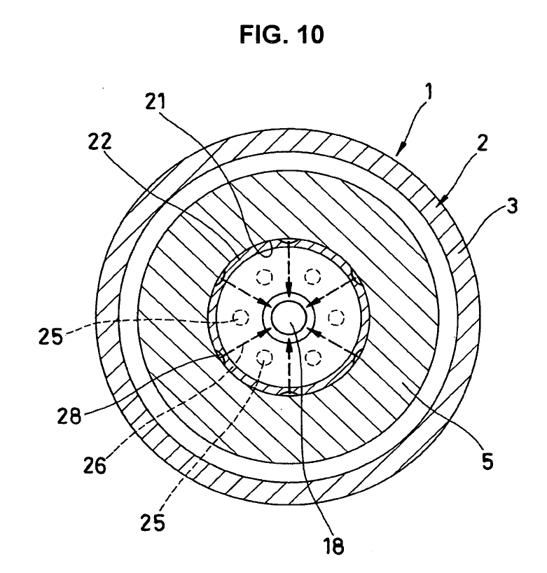

In addition to the structure of the first embodiment mentioned above, as shown in FIGS. 9 and 10, a vertically extending groove-shaped recess portion 28 is formed in the outer peripheral surface 22e of the seal holder 22, and the recess portion 28 is used as a part of the pressure relief path 26. In accordance with the structure mentioned above, since the sectional area of the opening of the pressure relief path 26 is substantially increased in the portion, it is possible to quickly relieve the pressure in the same manner. In this case, in the first embodiment mentioned above, since the pressure relief paths 26 are set at a plurality of positions on the circumference, it is preferable that the recess portions 28 are formed at a plurality of positions on the circumference. In the drawing, since the pressure relief paths are set at six positions on the circumference, the recess portions 28 are formed at six positions on the circumference. Further, it is preferable that the recess portion 28 is arranged at an intermediate position between the adjacent weld portions 25 and 25 on the circumference.

Further, in the first to fourth embodiments, the pressure relief path 26 is provided as the gap-shaped or recess-shaped structure between the seal holder attaching portion 21 and the seal holder 22, however, the pressure relief path 26 may be provided as a through hole shaped structure in the housing 2 or the seal holder 22 in place thereof. Embodiments thereof are as follows.

### Fifth Embodiment

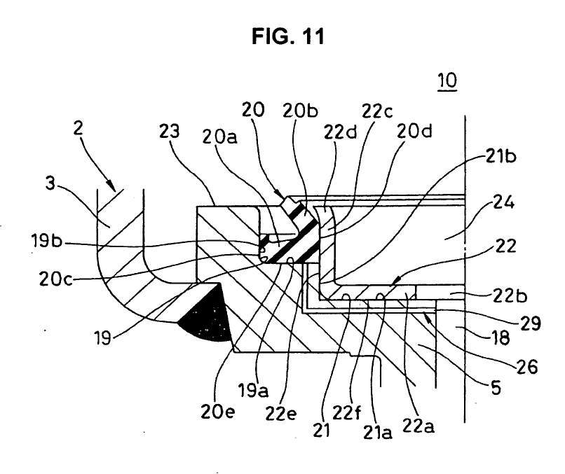

As shown in FIG. 11, a through hole 29 is formed in the oil port 5 structuring the housing 2, and the through hole 29 serves as the pressure relief path 26. The through hole 29 is open to the bottom surface 19a of the seal attaching portion 19 and the inner surface of the pressure inflow port 18, and connects the seal attaching portion 19 with the pressure inflow port 18.

### Sixth Embodiment

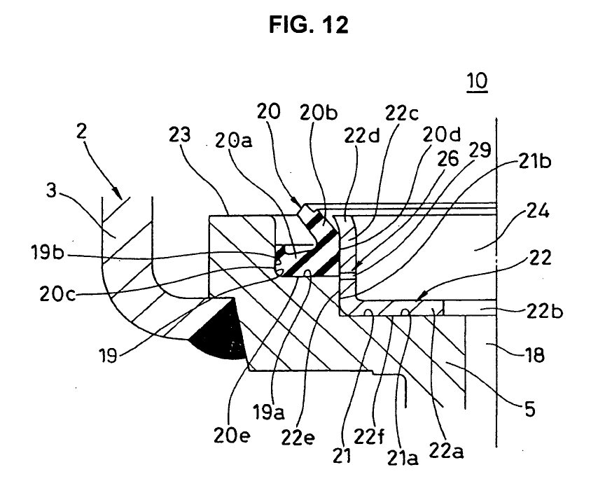

As shown in FIG. 12, the through hole 29 is formed in the seal holder 22, and the through hole 29 serves as the pressure relief path 26. The through hole 29 is open to the outer peripheral surface and the inner surface of the tubular portion 22c of the seal holder 22, and connects the seal attaching portion 19 with the chamber space 24.

1. An accumulator comprising: a seal attaching portion attaching a seal with which a working member such as a bellows a bellows cap and the like is freely brought into contact and released; and a seal holder attaching portion attaching a seal holder holding said seal; said seal attaching portion and said seal holder attaching portion being provided around a pressure inflow port inside an inner surface of a housing receiving said working member; said seal being attached to said seal attaching portion; and said seal holder being attached to said seal holder attaching portion by a fixing means such as welding, bonding, screwing, engaging or fitting, wherein the accumulator is provided with a pressure relief path relieving a pressure sealed in said seal attaching portion by attaching of said seal to the outside of said seal attaching portion

2. The accumulator as claimed in claim 1, wherein the pressure relief path is provided as a gap-shaped structure between the seal holder attaching portion and the seal holder attached to the seal holder attaching portion.

3. The accumulator as claimed in claim 2, wherein the pressure relief path is provided between said seal holder and the seal holder attaching portion by welding of the seal holder to the seal holder attaching portion in a part on the circumference thereof.

4. The accumulator as claimed in claim 2, wherein a plurality of pressure relief paths are provided between said seal holder and the seal holder attaching portion and between the weld portions by welding of the seal holder to the seal holder attaching portion at a plurality of positions on the circumference thereof.

5. The accumulator as claimed in claim 1, wherein a gap is provided between said seal holder and the seal holder attaching portion by loose fitting of the seal holder to the seal holder attaching portion and the gap serves as a part of the pressure relief path.

6. The accumulator as claimed in claim 1, wherein a groove-shaped or notch-shaped recess portion is provided in an inner surface of the seal holder attaching portion or a surface of the seal holder opposing to said inner surface, and said recess portion serves as a part or the entire of the pressure relief path.

7. The accumulator as claimed in claim 1, wherein the pressure relief path is provided as a through hole shaped structure in the housing or the seal holder.

8. The accumulator as claimed in claim 1, wherein the housing has a shell and an oil port connected to the shell, and the seal attaching portion and the seal holder attaching portion are provided in an inner surface of said oil port.
